(19) United States
(12) Patent Application Publication
(10) Pub. No.: US 2003/0231616 A1
(43) Pub. Date: Dec. 18, 2003

(54) Method of transporting voice over internet protocol via public access internet workstations

(76) Inventor: Shervin Rashti, Los Angeles, CA (US)

Correspondence Address: CISLO & THOMAS, LLP, 233 WILSHIRE BLVD, SUITE 900, SANTA MONICA, CA, 90401-1211, US

(21) Appl. No.: 10/172,097

(22) Filed: Jun. 14, 2002

(51) Int. Cl. H04L 12/66

(52) U.S. Cl. 370/352; 370/493; 370/400; 379/88.17

(57) ABSTRACT

A voice enabled public access Internet workstation including an improved method of transporting voice over Internet protocol is disclosed. Using one connection to the Internet, voice packets are prioritized through the use of a router and sent via a private managed network faster, minimizing packet delay and loss. The voice packets can be sent to any point of presence in the United States or the rest of the world by a gateway and gatekeeper recognizing a specific static IP address and allowing the voice packets to terminate in a global scale via Voice over Internet Protocol carriers national and or international set of gateways, or the Public Switching Telephone Network, depending upon the route codes of the Voice over Internet Protocol. These carriers never reach the public Internet domain, allowing good quality transmission with limitation on packet loss to be sent to any destination telephone in the world.

### BACKGROUND OF THE INVENTION

1. Field of the Invention

This invention relates generally to transferring information from an independent station over the world wide web and specifically utilizing packet switching technology for the effective transmission of voice packets from an independent station across the world wide web and into homes and businesses via telephone systems.

2. Description of the Related Art

Public communication services using independent stations are well known in the art. Many independent devices called kiosks exist in the art today allowing a user to access the world wide web and possibly telephone services. Hillson et al., U.S. Pat. No. 6,118,860 discloses one such kiosk.

In Hillson et al., an apparatus for vending public communications services including a public communication services kiosk apparatus having a computer, keyboard and telephone mounted thereon is disclosed. The telephone is in communication with a public telephone network via a central office telephone line and the computer is connected to a central server by a communications link such as an Ethernet connection. The aforementioned art is not Packetized voice transmission; instead, it is traditional circuit switched technology that has been in existence since the inception of the telephone. Also, the prior art uses dedicated phone lines and therefore needs to have two connections, one telephone line connection using a telephone network and a connection to a central server such as an Ethernet connection.

Currently, when mentioning Voice over Internet Protocol, there are many quality of service issues that exist. Data on the Internet travels using packet-switching technology, whereby information is sent in packets through the world wide web and arrives at its destination in these packets. The current challenges in using voice for these methods are echoes, delay sensitivity, packet loss, choppy voice quality and latency. If there are packet losses with data transmissions, there is still a chance that the message you will be receiving (i.e. via email) will be understood. It is not the same with voice transmissions because the loss of packets will cause a garbled transmission and lack of understanding from the end user.

Problems exist with the prior art because in order for efficient voice transmission to travel over the world wide web without an echo or interruption in the transmission, there needs to be a delay of less than 150 milliseconds. There has been no efficient, cost effective way of transporting voice from single unit locations to any given telephone number within the global PSTN (Public Switched Telephone Network). Voice transmission is normally transmitted via phone lines using circuit switching technology. By this method, a phone line from the sender and receiver is in use and allows no other transmission via this line, thereby blocking that line from other users. Unfortunately, this method is not efficient and does not allow any additional users to utilize the same lines for communication.

The reason these problems exist is that the world wide web is a best effort network. Voice and video transmissions are extremely delay sensitive, while data transmission is not. Even if a data transmission, such as an email, requires a three second delay, the message is still going to be received with no loss to the receiver. If this three-second delay also occurs for the voice transmission, problems will occur such as a garbled message or an echo. One of the problems that exist is that there is bandwidth inefficiency, whereby network applications pour tons of data into the network and literally cause congestion on the world wide web.

Traditional “Internet Telephony” allows you to speak to someone at a personal computer, from your personal computer. Even on the most advanced systems, the sound quality is poor. Programs available through the world wide web also have the ability to send voice through a microphone on the personal computer to someone's phone line. However, the quality of the transmission is poor and at many instances, communications are lost.

Therefore what is needed in the art is an efficient cost-effective method of transporting voice from single unit locations to any given telephone number within the global PSTN that will allow for time effective transfer of voice packets with less than 150 milliseconds of time delay.

### SUMMARY OF THE INVENTION

The present invention, which may be referred to as a Voice Enabled Public Access Internet Workstation (VE-PAIW) comprises a system for transporting voice over the Internet via a public access Internet workstation that includes a voice-enabled Internet access device, and a programmable circuit for converting voice data to digital data, and for directing said digital data to a voice gateway for further transmission to a Public Switched Telephone Network, whereby said programmable circuit prioritizes voice data packets over other data packets. The Internet access device may be a computer, and is preferably a multimedia workstation, although any device providing voice and data transmission to the Internet may be used. The Internet access device may use a static IP address, and may connect to an Internet Service Provider through a Local Area Network interface, that preferably provides a backhaul capacity of 5.1 k-9.6 k over the Internet Service Provider into the Voice Gateway. The programmable circuit for directing voice data to the voice gateway may be a router; preferably a router dedicated to voice data, but may also be a PC card.

An alternative embodiment of the present invention comprises a method of vending packet switched communication access that includes providing to a user an Internet access device with a static IP address, and capable of transmitting voice and data packets to the Internet, connecting the Internet access device to the Internet for further connection to a voice gateway that transmits said voice communication to a Public Switched Telephone Network, such that the delay in transmission to a recipient does not exceed 150 milliseconds. The voice communication is sent to the voice gateway via the Internet by a programmable circuit, which is preferably a dedicated router, but may be a PC card. The programmable circuit may give higher priority to voice communication packets than to other-data packets, and enables a data stream of 5.1-9.6 k per use.

An additional embodiment of a system for transporting voice over the Internet via a public access Internet workstation includes a voice-enabled Internet access device with a static IP address, that connects to an Internet Service Provider through a Local Area Network that has an interface for connecting to the Internet, and a programmable circuit for converting voice data to digital voice communication packets, that enables a data stream of approximately 5.1 k-9.6 k per use, and directs the voice communication packets to a voice gateway while giving higher priority to voice communication packets than to other data packets for further transmission to a Public Switched Telephone Network, such that the delay in transmission to a recipient preferably, but not necessarily, does not exceed 150 milliseconds.

The Voice Enabled Public Access Internet Workstation (VE-PAIW) does not use traditional “Internet telephony” to transport voice data packets, but rather a series of proprietary hardware compressions, proprietary software compressions, specific forms of Internet connection, specific forms of IP/ATM routing of data packets, specific cross carrier bridging techniques, as well as specific forms of Internet Protocol (IP) network management. This technology, known as “convergence technology”, brings together voice and data packets and combines (converges) them onto a single Internet Service Provider (ISP) connection, through any Local Access Network (LAN) interface, analog modem interface, USB interface, or any other kind of Internet connection with static IP addressing. The elements for completing a Voice over IP (VoIP) call utilizing the present invention includes a Static IP Address through a LAN interface to the ISP (i.e. SDSL, T-1, Wireless, etc.), a Motorola® Vanguard® series Router, or any compatible router, a backhaul capacity for 5.1 k-9.6 k over an ISP network into a public or private data network and gateway compatibility.

As currently configured, in order to complete a VE-PAIW to Public Switched Telephone Network (PSTN) phone call via an ISP connection, one distinct web address is required. The web address used is for the VE (Voice Enabled) portion of VE-PAIW. This static IP address is assigned to the Voice router. The router comprises the data routing functions, prioritizing voice and data as required to ensure quality voice packet transmissions via the ISP connection, which process the standard computer functions and Internet access portion. A kiosk is in communication with the router at the start of, during and at the end of voice conversations. This way, the kiosk controls the rates the end user is charged for that phone call, ensuring that payment has been made for the entire duration of the call. The kiosk software also enables the end user to conduct numerous tasks while talking on the phone. These tasks currently include checking/sending email, sending full motion audio/video email clips, surfing the Internet, and numerous other tasks that guide the users to websites related to their interest.

Many types of gateway routers may be used in this art, the Motorola® Vanguard® series routers is one of the options. These routers are the mainstay of the US ATM (Automatic Teller Machine) network and have the capability to handle voice and data over an ISP connection to the Internet. The routers use a proprietary set of hardware and software compressions that enable VoIP data streams of from 5.1 k-9.6 k per use. The main component within the Motorola® Vanguard® series routers which enables the VE-PAIW to be so successful in regards to quality of voice is that the software gives priority for all voice packets over regular computer generated data packets. This enables voice packets to reach the data network more quickly, which minimizes packet delay and loss so that the quality is maintained at industry standard levels.

The third element that is unique to the VE-PAIW is the method of initial transport. The present invention is able to effect a quality VoIP voice session utilizing a single ISP connection, and send both voice packets and data packets, and does not require a router or PC to be present at the other end. Most VoIP applications are currently “point to point”, essentially linking two locations with the same gateway (i.e., Vanguard series or equivalent competing product). The VE-PAIW is capable of VoIP from a single location to any telephone in the world.

The VE-PAIW uses convergence technology. Convergence technology is the ability to merge two or more separate data streams into a single circuit. This allows the ability to transport the voice and data portions of the traffic to the Internet network where the voice portion, a data stream of from 5.1 k-9.6 k, gets directed to the originating VoIP carrier's gateway. In effect, with this technique, the voice portion of the data stream can be sent to any point of presence in the United States at no cost, on a per minute basis. The “backhauled” voice portion arrives at the VoIP carrier with a specific static IP address that is recognized by the VoIP carriers gateway and gatekeeper, and the call is allowed to terminate on a global scale via the VoIP carrier's national and or international set of gateways, or the PSTN, depending upon the route codes of the VoIP carrier.

The VoIP carrier is typically a public network, but may be a 100% managed network. This means that the voice packets that comprise the voice portion of the Internet session flow over IPLC (International Private Leased Lines) to countries of destination. The voice packets, therefore, once “handed off” to the VoIP carrier, never are allowed to reach the public Internet domain, so the quality can be maintained.

### OBJECTS OF THE INVENTION

It is an object of the present invention to provide an improved method of transporting voice over Internet protocol via public access Internet workstations.

It is another object of the present invention to prioritize voice transmission utilizing a single Internet service provider connection.

It is yet another object of the present invention to provide voice transmission to any point in the United States or the rest of the world at little or no cost.

It is another object of the present invention to combine that high quality voice call with high speed Internet access. Thereby, allowing the end user to multitask and conduct business or leisure activities at a public workstation.

These and other objects and advantages of the present invention will be apparent from a review of the following specification and accompanying drawings.

### BRIEF DESCRIPTION OF THE DRAWINGS

FIG. 1 is a flowchart of the path of voice and data packets using the present method.

FIG. 2 is a front view of an example of a kiosk with an Internet connection that uses the present method.

FIG. 3 is a front view of an example of a router used in the present method.

FIG. 4 is a rear view of an example of a router used in the present method.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

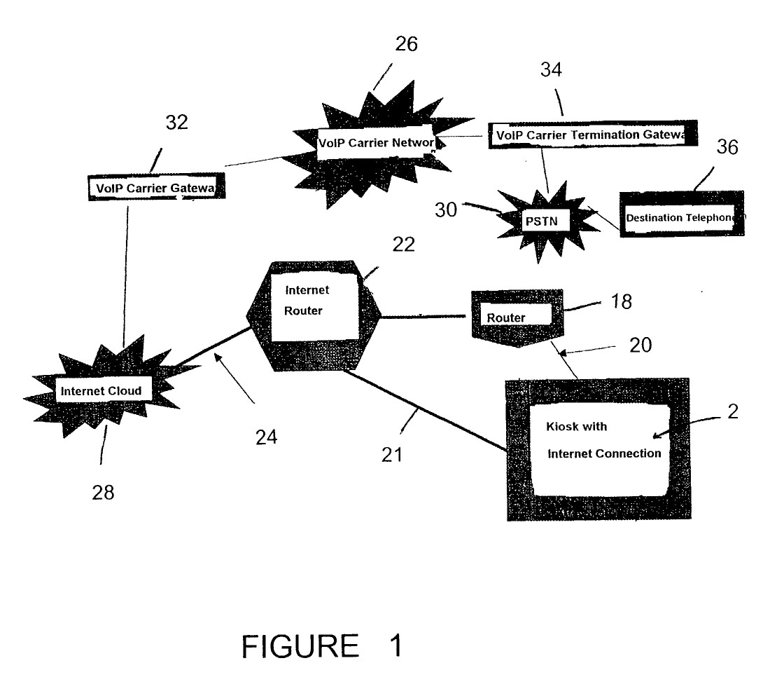

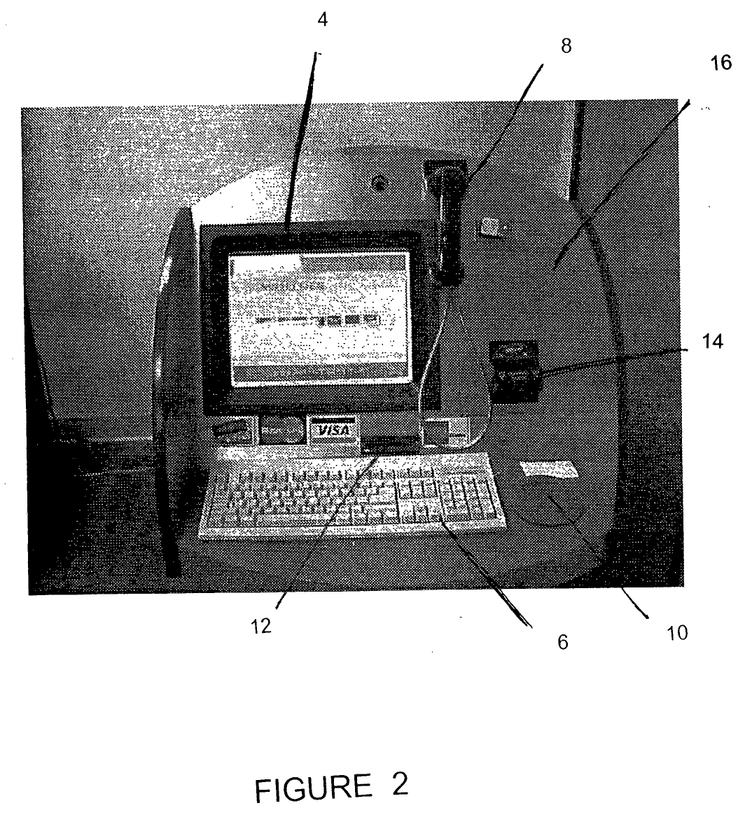

In FIG. 1, a flow chart of the path of voice and data packets using the present method is shown. A kiosk 2, as shown in FIG. 2, having a computer (not shown) with monitor 4, keyboard 6, telephone handset 8, motion sensor mouse pad 10, modem (not shown), credit card accepting apparatus 12 and a bill collecting apparatus 14 is an example of a public access Internet workstation 16 that implements the present method. The features involved in the completion of voice prioritization through use of the Voice Enabled Public Access Internet Workstation (VE-PAIW) are 1) A static IP address through a LAN interface to an ISP, 2) A programmable circuit, such as a Motorola® Vanguard series router 18, or any compatible router or PC card, 3) Backhaul capacity for 5.1 k-9.6 k over Internet Service Provider network 28 into a VoIP network 26, and 4) gateway compatibility.

As currently configured, in order to complete a VE-PAIW to PSTN phone call via an ISP connection, as shown in FIG. 1, one distinct Internet address is required. The Internet address used is for the voice enabled portion of the VE-PAIW. The static IP address can be assigned to a Motorola® Vanguard® series router 18 or other compatible router. The router 18 comprises the data routing functions, prioritizing voice and data as required to ensure quality voice packet transmissions via the ISP connection, which process the standard computer functions and Internet access portion.

Alternatively, other programmable circuits such as PC cards, line jacks or phone jack may be used. Examples of these devices include Internet Phone Jack™, Internet Line Jack™ and Internet Phone Card™, although many other suitable devices will suffice.

If a PC card is used, it should preferably be a Type II PCMCIA (Personal Computer Memory Card International Association) card suitable for PC-to-PC, PC-to-phone and web-to-PBX (Private Branch Exchange) applications. Should a line jack be preferred, it should be suitable for PC-to-PC, PC-to-phone, phone-to-PC, and web-to-phone applications. A phone jack should be suitable for PC-to-PC and PC-to-phone applications.

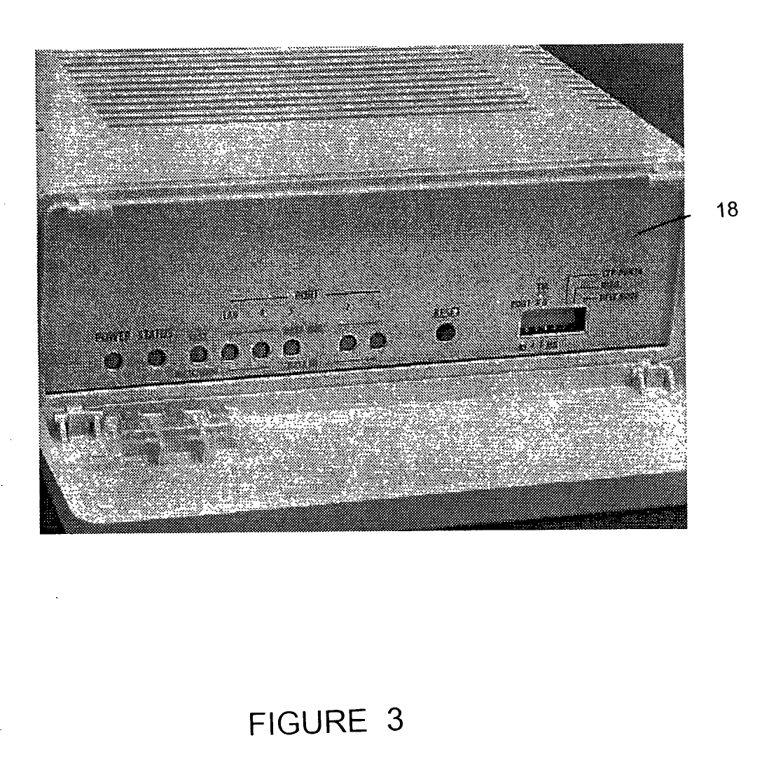

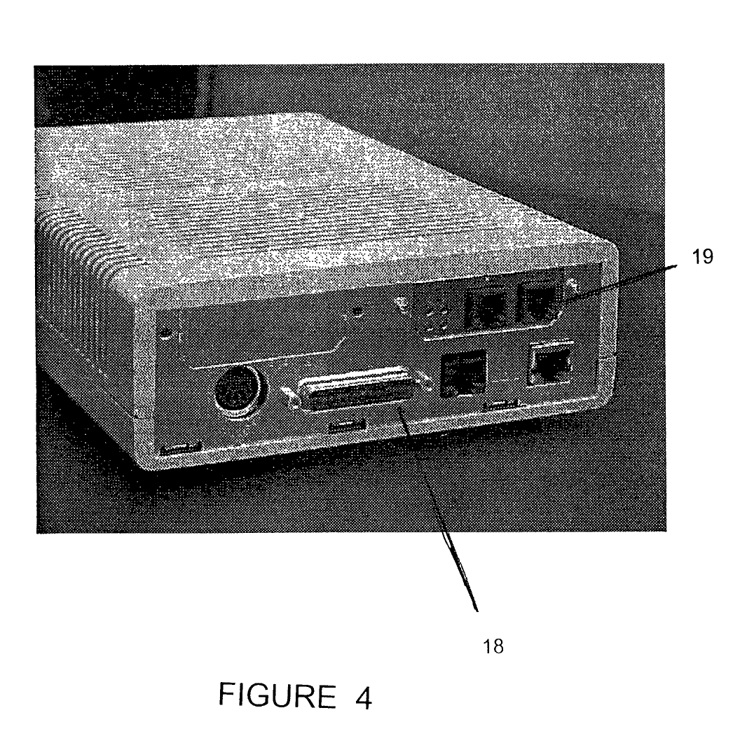

In one embodiment, a static IP address is used for the kiosk 2 and the voice router 18, however dynamic IP addresses may also be used in conjunction with the present method. Connections extend from the kiosk 2 to other devices allowing the voice and data packets to be transported. A telephone handset 8, which uses the computer modem to emulate DTMF tones, connects into an FSX port 19 in a voice router 18, thereby allowing voice packets to take a separate route 20 than data packets route 21. In the preferred embodiment, a Vanguard® 320 router 18, as shown in FIGS. 3 and 4, is used, but other routers with similar properties can also be used in conjunction with this method. It is further understood that this configuration can be modified such that there will be no need for a voice router 18 at the kiosk 2 site. Instead, there would be a series of software compressions working in conjunction with a PC card to handle the voice digitization, compression, and packetization. Thereby, sending the voice packets to the initial portion of the diagram where the primary gateway 32 would complete the tasks as described herewith. Through a static IP address, the voice packets using a 5.1 k-9.6 k data stream are prioritized over regular computer generated data packets and then pass through an Internet router 22 that provides IP addresses and a connection to the Internet 24. This prioritization enables the voice packets to reach a data network 26 faster, which minimizes packet delay and loss so that the quality is maintained.

The method of initial transport of the VoIP 26 uses a single ISP connection, and sends both voice packets and data packets without requiring a router 18 to be present at the point where the transmission is being received. The present method is capable of linking VoIP 26 from a single location, such as a kiosk 2, to anywhere in the world. An Ethernet or similar connection exists from the kiosk 2 to the Internet router 22 or hub allowing one single connection to the Internet, distinguishing this method from the prior art. In the preferred embodiment, separate routers 18, a voice router 18 and an Internet router 22 or hub, are used, but one router 18 may be combined in order to achieve the same results.

The present method uses an ability to merge two or more separate data streams into a single circuit. The voice portion can be sent to any point of presence in the United States or the rest of the world by the VoIP carrier network 26 by the gateway and gatekeeper recognizing a specific static IP address and allowing the voice portion to terminate on a global scale via VoIP carriers national and or international set of gateways, or the Public Switched Telephone Network (PSTN) 30, depending upon the route codes of the Voice over Internet Protocol (VoIP) carrier. Once through the Internet router 22, the voice packets break off and travel into a carrier gateway 32 that travels over a data network 26 to a termination gateway 34 where the voice packets are delivered to a PSTN 30. From the PSTN 30, the voice packets are delivered to any destination telephone 36 in the world.

While the present invention has been described with regards to particular embodiments, it is recognized that additional variations of the present invention may be devised without departing from the inventive concept.

What is claimed is:

1. A system for transporting voice over the Internet via a public access Internet workstation comprising:
a voice-enabled Internet access device;
a programmable circuit for converting voice data to digital data, and for directing said digital data to a voice gateway for further transmission to a Public Switched Telephone Network, whereby said programmable circuit prioritizes voice data packets over other data packets.

2. The system of claim 1 wherein the Internet access device comprises a computer.

3. The system of claim 1 wherein the Internet access device comprises a multimedia workstation.

4. The system of claim 2 wherein the Internet access device uses a static IP address.

5. The system of claim 4 wherein the Internet access device connects to an Internet Service Provider through a Local Area Network interface.

6. The system of claim 5 wherein there is backhaul capacity for 5.1 k-9.6 k over the Internet Service Provider into the Voice Gateway.

7. The system of claim 6 wherein the programmable circuit for directing voice data to the voice gateway comprises a router.

8. The system of claim 6 wherein the programmable circuit for directing voice data to the voice gateway comprises a PC card.

9. The system of claim 3 wherein the Internet access device uses a static IP address.

10. The system of claim 9 wherein the Internet access device connects to an Internet Service Provider through a Local Area Network interface.

11. The system of claim 10 wherein there is backhaul capacity for 5.1 k-9.6 k over the Internet Service Provider into the Voice Gateway.

12. The system of claim 11 wherein the programmable circuit for directing voice data to the voice gateway comprises a router.

13. The system of claim 11 wherein the programmable circuit for directing voice data to the voice gateway comprises a PC card.

14. A method of vending packet switched communication access comprising:
providing to a user an Internet access device with a static IP address and capable of transmitting voice and data packets to the Internet;
connecting said Internet access device to the Internet for further connection to a voice gateway, wherein said voice gateway transmits said voice communication to a Public Switched Telephone Network, whereby the delay in transmission to a recipient does not exceed 150 milliseconds.

15. The method of claim 14 wherein voice communication is sent to the voice gateway via the Internet by a programmable circuit.

16. The method of claim 14 wherein voice communication is sent to the voice gateway via the Internet by a router.

17. The method of claim 14 wherein voice communication is sent to the voice gateway via the Internet by a PC card.

18. The method of claim 15 wherein the programmable circuit gives higher priority to voice communication packets than to other data packets.

19. The method of claim 18 where the programmable circuit enables a data stream of 5.1-9.6 k per use.

20. A system for transporting voice over the Internet via a public access Internet workstation comprising:
a voice-enabled Internet access device,
said Internet access device having a static IP address; wherein the Internet access device connects to an Internet Service Provider through a Local Area Network, having an interface for connecting said Internet access device to the Internet; and
a programmable circuit for converting voice data to digital voice communication packets, said programmable circuit enabling a data stream of approximately 5.1 k-9.6 k per use, whereby said programmable circuit directs said voice communication packets to a voice gateway and the programmable circuit gives higher priority to said voice communication packets than to other data packets for further transmission to a Public Switched Telephone Network whereby the delay in transmission to a recipient does not exceed 150 milliseconds.
